(19) United States
(12) Patent Application Publication
(10) Pub. No.: US 2026/0203105 A1
(43) Pub. Date: Jul. 16, 2026

(54) SYSTEM FOR DISTRIBUTED MACHINE LEARNING INFERENCE IN PRIVATE NETWORK ENVIRONMENT AND OPERATING METHOD THEREOF

(71) Applicant: Vessl AI Korea Inc., Gwangju (KR)

(72) Inventors: Seung Won SHIN, Seoul (KR); Min Kyu KIM, Seongnam-si (KR); Hyun Su LIM, Seoul (KR)

(73) Assignee: Vessl AI Korea Inc., Gwangju (KR)

(21) Appl. No.: 19/270,816

(22) Filed: Jul. 16, 2025

(30) Foreign Application Priority Data
Jan. 15, 2025 (KR) 10-2025-0006094

(51) Int. Cl. G06F 9/48; G06F 9/4401

(52) U.S. Cl. CPC G06F 9/4881; G06F 9/4418

(57) ABSTRACT

Disclosed is a system for distributed machine learning inference in a private network environment. The system includes a user device, a serve queue that receives an inference request from the user device, stores identification information of the inference request in a message queue, schedules the inference request received from the message queue by using autoscaling, based on stack information of the message queue and activation information of a plurality of servers, and performs a scale-to-zero on a first server among the plurality of servers when the first server among the plurality of servers satisfies a preset reference. Each of the plurality of servers generates an inference result in response to the inference request allocated from the serve queue.

### CROSS-REFERENCE TO RELATED APPLICATIONS

This application claims priority under 35 U.S.C. § 119 to Korean Patent Application No. 10-2025-0006094 filed on Jan. 15, 2025, in the Korean Intellectual Property Office, the disclosures of which are incorporated by reference herein in their entireties.

### BACKGROUND

Embodiments of the present disclosure described herein relate to a distributed machine learning inference system for a private network environment and an operating method thereof, and more particularly, relate to a distributed machine learning inference system enabling efficient resource utilization and asynchronous request processing through a serverless architecture in a private network environment and an operating method thereof.

Nowadays in the information technology environment, artificial intelligence (AI) and machine learning (ML) play an important role in various fields. In the AI and ML techniques, a model is trained to perform a specific task based on a large amount of data, and the trained model yields a prediction or classification result associated with input data such that a customized service or an advanced analysis result is provided. A machine learning model is being utilized in various applications such as image recognition, natural language processing, and speech recognition. In particular, a fast and efficient machine learning inference system is essential in an application which requires real-time inference (e.g., autonomous driving, security surveillance, or industrial automation).

Nowadays, the machine learning inference is mostly done in a cloud environment. Even though a cloud provides high processing power and scalability, the cloud may have limitations such as data transmission delay (Latency), security issues, privacy issues, and dependency on Internet connection. In particular, an existing cloud-centric approach may not be appropriate in a private network environment dealing with sensitive data or in a private network environment with limited network connectivity.

To address this, a distributed machine learning inference system is attracting attention. Because the distributed machine learning inference system distributes and processes tasks into multiple devices or servers, it may be possible to reduce the delay, to minimize the network traffic, and to improve security by keeping data locally.

The present disclosure is directed to provide a distributed machine learning inference system for a private network environment.

A system which performs an inference process is required to utilize a pre-trained machine learning model in a real working environment. The system which performs the inference process receives input data, derives a result through a model, and provides the derived result to the user. The system operates in a distributed environment to efficiently process inference requests in quantity and performs parallel processing by utilizing multiple server computers.

However, a conventional distributed machine learning inference system fails to support “scale-to-zero” fully. In particular, the conventional distributed machine learning inference system does not support an asynchronous request management function which temporarily holds (or queues) the inference request and then processes the inference request after the server wakes up.

Due to the above issues, it is difficult to completely implement a serverless architecture and to manage resources efficiently.

Accordingly, the inventor(s) of the present disclosure solves the above limitations or difficulties and develops a new distributed machine learning inference system which operates in a private network environment and provides an autoscaling function.

Problems to be solved by the present disclosure are not limited to the above problems, and other problems not mentioned herein may be clearly understood from the specification and the accompanying drawings by one skilled in the art to which the present disclosure pertains.

### SUMMARY

According to an embodiment, a system for distributed machine learning inference in a private network environment may include a user device, and a serve queue that receives an inference request from the user device, stores identification information of the inference request in an asynchronous message queue whose execution time is dynamically determined, schedules the inference request by using autoscaling, based on stack information of the message queue and activation information of a plurality of servers, and when a first server among the plurality of servers satisfies a preset reference, performs a scale-to-zero on the first server by transmitting an end signal to the first server, and when all of the plurality of servers are inactive, to perform a 0-to-1 to activate at least one of the plurality of servers by transmitting a wakeup signal to at least one of the plurality of servers. Each of the plurality of servers may generate an inference result in response to the inference request allocated from the serve queue. The preset reference is the case where at least one of the plurality of servers is in an inactive during a first time determined in advance and an inference request is not received from the user device during a second time determined in advance.

According to another aspect of the present disclosure, the inference request may include a first inference request, and the serve queue may detect the first inference request failing in generation of an inference result, may control the message queue such that a priority of the first inference request becomes higher, and may again transmit the first inference request to a second server among the plurality of servers.

According to another aspect of the present disclosure, the inference request may include a second inference request, and when the second inference request is received and the plurality of servers are in a 0-to-1 situation, the serve queue may transmit a wakeup signal to a third server among the plurality of servers, may store the second inference request in the message queue to hold the second inference request, and may transmit the second inference request to the third server among the plurality of servers after a third time determined in advance.

According to another aspect of the present disclosure, the system for distributed machine learning inference may further include a storage including an input storage and an output storage, the input storage may store data associated with the inference request, and the output storage may store data associated with the inference result.

According to another aspect of the present disclosure, the autoscaling may be to dynamically determine whether to activate each of the plurality of servers by using a horizontal pod autoscaler (HPA) function of Kubernetes.

According to an embodiment, an operating method for distributed machine learning inference in a private network environment may include receiving an inference request from a user device, the inference request including a first inference request and a second inference request, storing identification information of the inference request in an synchronous message queue whose execution time is dynamically determined, scheduling the inference request by using autoscaling, based on stack information of the message queue and activation information of a plurality of servers, transmitting an end signal to the first server among the plurality of servers, when a first server among the plurality of servers satisfies a preset reference, performing a scale-to-zero on the first server by transmitting an end signal to the first server, and when all of the plurality of servers are inactive, performing a 0-to-1 to activate at least one of the plurality of servers by transmitting a wakeup signal to at least one of the plurality of servers. Each of the plurality of servers are configured to generate an inference result in response to the inference request allocated from the serve queue. The preset reference is the case where at least one of the plurality of servers is in an inactive during a first time determined in advance and an inference request is not received from the user device during a second time determined in advance.

According to an embodiment, a non-transitory computer-readable recording medium having recorded thereon a computer program for executing an operating method for distributed machine learning inference in a private network environment. the operating method comprises receiving an inference request from a user device, wherein the inference request includes a first inference request and a second inference request, storing identification information of the inference request in an asynchronous message queue whose execution time is dynamically determined, scheduling the inference request by using autoscaling, based on stack information of the message queue and activation information of a plurality of servers, when a first server among the plurality of servers satisfies a preset reference, performing a scale-to-zero on the first server by transmitting an end signal to the first server, and when all of the plurality of servers are inactive, performing a 0-to-1 to activate at least one of the plurality of servers by transmitting a wakeup signal to at least one of the plurality of servers. Each of the plurality of servers are configured to generate an inference result in response to the inference request allocated from the serve queue. The preset reference is the case where at least one of the plurality of servers is in an inactive during a first time determined in advance and an inference request is not received from the user device during a second time determined in advance.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a conceptual diagram illustrating a distributed machine learning inference system according to a comparative example of the present disclosure.

FIG. 2 is a block diagram illustrating a distributed machine learning inference system according to a comparative example of the present disclosure.

FIG. 3 is a block diagram illustrating a configuration of a distributed machine learning inference system according to an embodiment of the present disclosure.

FIG. 4 is a block diagram illustrating a configuration of a computing device for distributed machine learning inference according to an embodiment of the present disclosure.

FIG. 5 is a block diagram illustrating an example of an operation of a distributed machine learning inference system according to an embodiment of the present disclosure.

FIG. 6 is a flowchart illustrating an operating method of a computing device for distributed machine learning inference according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

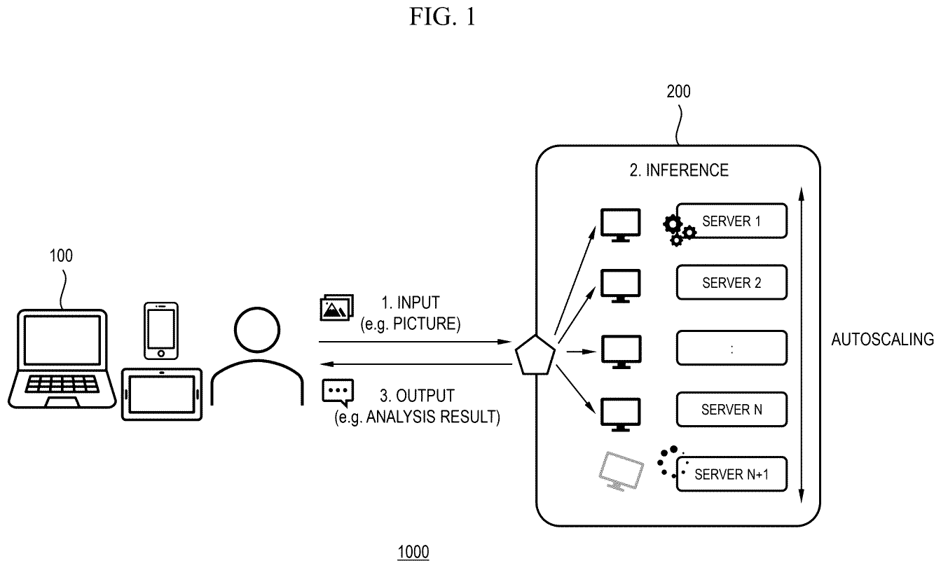

FIG. 1 is a conceptual diagram illustrating a distributed machine learning inference system according to a comparative example of the present disclosure.

Referring to FIG. 1, a distributed machine learning inference system 1000 according to a comparative example of the present disclosure may include a user device 100 and/or a plurality of servers 200. In the specification, a “server” may be referred to as a “computing resource”, a “computational resource”, a “server resource”, or a “server computer”.

A system (e.g., the distributed machine learning inference system 1000) which performs an inference process is required for a real user to utilize a pre-trained machine learning model in a working environment. As an example, the user may input a picture by using the user device 100 and may request the plurality of servers 200 to infer an analysis result associated with the picture.

In a comparative example of the present disclosure, the plurality of servers 200 may be built in the form of a cluster. Referring to FIG. 1, the plurality of servers 200 may include (N+1) server computers. The plurality of servers 200 may be components which the user holds and is built in the private network environment. The plurality of servers 200 may implement a computational resource which includes hardware resources, which are necessary at respective stages of a machine learning lifecycle, such as a central processing unit (CPU), a graphic processing unit (GPU), a memory, and storage. Each of the plurality of servers 200 may execute an actual ML/AI workload. The plurality of servers 200 may be implemented based on a container and may be managed by using the Kubernetes.

To support the autoscaling, the distributed machine learning inference system 1000 according to a comparative example of the present disclosure may implement dynamic allocation of the server resource by utilizing a container orchestration platform such as Kubernetes. For example, the distributed machine learning inference system 1000 may deploy an inference service through a deployment function of the Kubernetes and may perform autoscaling according to a load by using the horizontal pod autoscaler (HPA). Also, the distributed machine learning inference system 1000 may adjust the number of real physical nodes by utilizing a cluster autoscaler.

Enormous computing resources (e.g., the plurality of servers 200) are required to operate a system, which performs a large-scale inference process, such as the distributed machine learning inference system 1000, resulting in resource waste and an increase in costs. In the case of utilizing the infrastructure of a cloud service provider, because costs increase depending on a used computing resource, efficient resource management is emerging as an important issue.

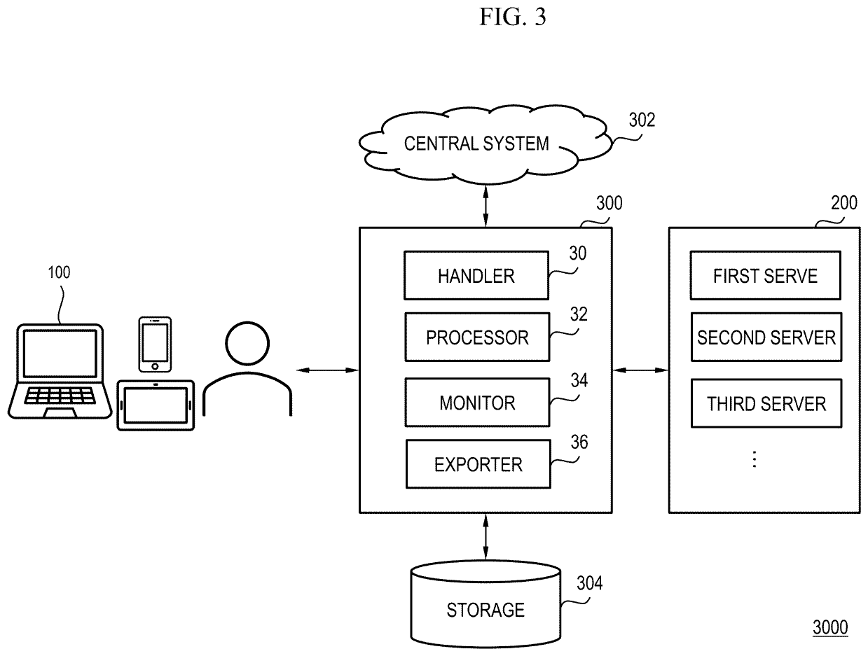

To address this, an autoscaling technology which dynamically adjusts the number of server resources is introduced to a distributed machine learning inference system (refer to 3000 of FIG. 3) according to an embodiment of the present disclosure. The “autoscaling” refers to a technology for automatically adjusting the number of servers depending on a system load to utilize resources efficiently. In particular, a “scale-to-zero” or “serverless” technology for scaling down the number of servers to “0” in an idle state of the system may maximize the efficiency of resource utilization.

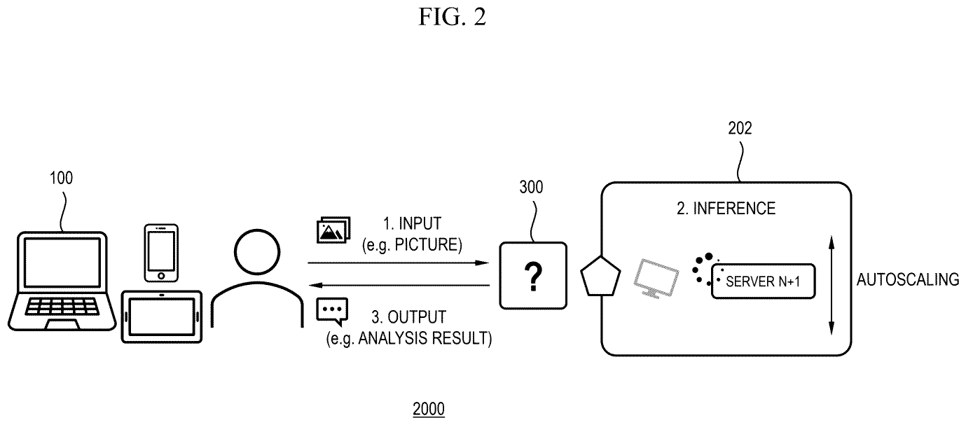

FIG. 2 is a conceptual diagram illustrating a distributed machine learning inference system according to a comparative example of the present disclosure.

Referring to FIG. 2, a distributed machine learning inference system 2000 in a 0-to-1 situation is illustrated. The distributed machine learning inference system 2000 in the 0-to-1 situation includes the user device 100 and a server 202. In FIG. 2, the server 202 indicates a state in which a server waking up is absent from a plurality of servers and one server is about to wake up.

The 0-to-1 situation refers to a situation in which a server computer (or a serverless application or service) for inference in serverless computing is again activated in response to the inference request received from the user device 100 in an inactive i.e. in the scale-to-zero.

The 0-to-1 situation may utilize advantages such as serverless flexibility and reduction of costs but requires the management of cold start which is an initialization delay issue to optimize performance.

However, the distributed machine learning inference system 2000 fails to support the “scale-to-zero” fully. The Kubernetes is designed to maintain at least one pod by default, and a function which scales down the number of pods to zero is restrictive. Also, when a plurality of servers receives the inference request from the user device 100 in a state where the number of servers waking up is “0”, because the plurality of servers are in the inactive, a mechanism which is immediately allocated a resource, loads an execution environment, and processes the request is insufficient, and an additional time is required to process the inference request. In particular, an asynchronous request management function which temporarily holds (or queues) the inference request and then processes the inference request after the server wakes up is not supported. That is, the distributed machine learning inference system 2000 in the 0-to-1 situation does not include a component 300 which asynchronously processes and manages the 0-to-1 situation in connection with the autoscaling, between the user device 100 and the server 202.

In this situation, there is required an efficient asynchronous processing manner in which a request from the user device 100 is held and is then processed after the server 202 wakes up. To implement the above manner, a request management and processing system utilizing a message queue is required, and it is necessary to design an integrated architecture of the entire system.

A pattern which holds (or queues) and processes the inference request by utilizing the message queue is well known, but an example in which the entire architecture is implemented by integrating the pattern and the distributed machine learning inference system is rare. In addition, additional development and complex settings are required to connect (or link) the conventional message queue system and the distributed machine learning inference system, and in particular, a solution capable of being utilized in the private network environment is insufficient.

Also, a task for detecting a state of the message queue so as to be applied to the operation of the distributed machine learning inference system is a technically complex task. To dynamically adjust the number of server resources depending on the length of the message queue and to guarantee the stability and efficiency of the corresponding system, it is necessary to configure and manage the entire system. Due to the above issues, an existing method has limitations in fully implementing a server-less architecture and efficiently managing resources.

FIG. 3 is a block diagram illustrating a configuration of a distributed machine learning inference system according to an embodiment of the present disclosure.

Referring to FIG. 3, a distributed machine learning inference system 3000 according to an embodiment of the present disclosure may include the user device 100, the plurality of servers 200, a serve queue 300, a central system 302, and/or storage 304.

The distributed machine learning inference system 3000 operates in the private network environment and is implemented with the architecture of a distributed machine learning inference system supporting the server-less architecture. To receive and process the inference request from the user device 100 and to manage the server resource efficiently, the distributed machine learning inference system 3000 may be configured with the serve queue 300 centered.

According to an embodiment of the present disclosure, the serve queue 300 may receive, hold (or queue), or process the inference request of the user and may respond to the inference request of the user. Also, the serve queue 300 may dynamically manage the plurality of servers 200 and may control the autoscaling.

The serve queue 300 may include a handler 30, a processor 32, a monitor 34, and/or an exporter 36. In the specification, the serve queue 300 and each of the components included in the serve queue 300 may refer to hardware capable of performing a function and an operation according to each name described in the specification, may refer to a computer program code capable of performing a specific function and a specific operation, or may refer to an electronic recording medium equipped with a computer program code capable of allowing a specific function and a specific operation to be performed. The serve queue 300 may be executed on the cloud which the user controls (or governs). The serve queue 300 may refer to a computing device for distributed machine learning inference in the private network environment or a portion of the computing device, or may be software built in the computing device. The serve queue 300 may mean a functional and/or structural combination of hardware for carrying out the technical idea of the present disclosure and/or software for driving the hardware.

The handler 30 may receive the inference request from the user device 100. The handler 30 may transfer or add the inference request received from the user device 100 to the message queue. The inference request which the handler 30 receives may be stored in the message queue. The handler 30 may detect inference results generated by the plurality of servers 200 in response to the inference request and may transmit the inference results to the user device 100. The handler 30 may monitor an output storage included in the storage 304. Whenever new result data are added, the handler 30 may transfer the added result data to the user device 100. Through the asynchronous request processing and the user response, the user may use the inference service in an environment, which is similar to an environment in which the user directly communicate with a real server, by using the serve queue 300, the message queue, and the output storage.

According to an embodiment of the present disclosure, the message queue utilizes the Redis for queuing and managing the inference request. The message queue may be provided in plurality. Because the serve queue 300 is capable of processing various kinds of inference requests simultaneously, the serve queue 300 can configure an independent message queue for each inference request. Also, an “in-flight queue” may be separately maintained to managing a request being currently processed. Below, the “message queue” may refer to one of a plurality of message queues included in the distributed machine learning inference system 3000 according to an embodiment of the present disclosure.

When the processor 32 fetches and processes the inference request from the message queue, information of the corresponding inference request may be recorded at the “in-flight queue”. The information of the corresponding inference request, which is recorded at the message queue, includes identification information and/or metadata of the inference request, and a time at which the processor 32 last sends a signal “under process”. When the signal “under process” is not received from the processor 32 during a given time, it is determined that an error occurs in the processor 32, and the monitor 34 again moves the corresponding request to the message queue so as to be again processed.

The processor 32 may schedule the inference request received from the message queue by using the autoscaling, based on stack information of the message queue and activation information of the plurality of servers 200. The stack information of the message queue may include information about how many inference requests are stored in the message queue and/or identification information of each of the stored inference requests. The activation information of the plurality of servers 200 may include information about the number of servers to which resources are allocated to perform inference (i.e., the number of activated servers), information about an activated server among the plurality of servers 200, etc.

As an example, when an activated server is absent from the plurality of servers 200, that is, in the case of the 0-to-1 situation, the processor 32 may transmit a signal for waking up at least one of the plurality of servers 200 and may again transfer and store the corresponding inference request received from the user device 100 to and in the message queue to hold (or queue) the corresponding inference request. The signal for waking up at least one of the plurality of servers 200 may be referred to as a “wakeup signal”. In this case, the processor 32 may set in such a way that the corresponding inference request is again processed after a preset time (e.g., at least 60 seconds), in consideration of a time at which at least one of the plurality of servers 200 wakes up.

As another example, when one or more activated servers are present in the plurality of servers 200, the processor 32 may select one of the one or more activated servers and may submit the inference request to the selected server. The processor 32 may receive an inference result of the submitted inference request from the corresponding server. The inference result received by the processor 32 may be stored in the output storage in real time.

The processor 32 may store the inference result of the machine learning model in the output storage included in the storage 304 in real time and may partition result data in units of given magnitude so as to be transferred to the user.

To maintain the stability of the system, the monitor 34 may continuously monitor the state of the distributed machine learning inference system 3000. The monitor 34 may perform the scale-to-zero, based on a preset reference and status information of the system. In the specification, the “predetermined reference” mans a reference for determining whether to perform the scale-to-zero. The “system status information” means real-time status information of the distributed machine learning inference system 3000 for processing the inference request received at a specific time, and the real-time status information may be obtained as a monitoring result of the monitor 34. The “system status information” may include stack information of a message queue at the specific time, the length of a specific message queue, activation information of the plurality of servers 200 at the specific time, etc.

As an example, when a given time (e.g., ten minutes) passes from the wakeup of a first server of the plurality of servers 200 and the inference request is not received during a given time (e.g., ten minutes) from the current time, the monitor 34 may transmit a signal for stopping the first server to the first server. Also, the monitor 34 may detect the inference request experiencing processing failure and may increase the priority of the message queue corresponding to the inference request experiencing processing failure such that the inference request is again processed. In this case, the stability of the system may be improved, and the reliability of the inference request may be guaranteed.

As described above, the distributed machine learning inference system 3000 for the private network environment according to an embodiment of the present disclosure may schedule the inference request by using the autoscaling and may perform the scale-to-zero, and thus, the number of servers may be dynamically adjusted and managed depending on the load of the system 3000.

The exporter 36 provides the outside with the system status information including the length of the message queue and the like. Herein, the outside may be the central system 302. Why the system status information is provided to the outside is to expose the metric so as to be utilized by the horizontal pod autoscaler (HPA) of the Kubernetes performing the autoscaling.

The plurality of servers 200 may generate the inference results in response to the inference request allocated from the serve queue 300. According to an embodiment, the plurality of servers 200 may be managed through the deployment function of the Kubernetes. As the central system 302 receives signals generated by the processor 32 and the monitor 34 of the serve queue 300 and adjusts the scale of the Kubernetes deployment, the wakeup and stop of each of the plurality of servers 200 are made. The scale means a process of adjusting the number of pods to process a workload of an application. In the case of adjusting one or more of the plurality of servers 200, the central system 302 collects the system status information including message queue length information which the exporter 36 provides, converts the collected system status information into the metric capable of being utilized by the HPA, provides the metric to the HPA, and performs the autoscaling of each server by using the HPA. However, when the number of pods is “0”, the monitor 34 according to an embodiment of the present disclosure performs the scale-to-zero, based on the preset reference and the system status information, and thus, the plurality of servers 200 are dynamically managed.

Because the input and output data of the machine learning model are a large amount of data, the storage 304 may be used to manage the input and output data efficiently. The storage 304 according to an embodiment may be storage or a database connected to the serve queue 300 in a wired or wireless manner, as illustrated. The storage 304 may be a simple data storage such as a key-value storage or a Blob storage. The storage 304 may include an input storage and/or an output storage. The storage 304 may store input data associated with the inference request and/or output data associated with the inference result. In contrast, the serve queue 300 stores and manages only identification information or metadata of the input data and/or the output data by using the message queue.

The user device 100 refers to a device of the user which intends to transfer the inference request for the specific task to the machine learning model. The user device 100 may include a smartphone, a tablet personal computer (PC), a notebook, a PC, etc. The user device 100 may install and/or execute a web, a mobile application, or a program which at least one server 200 for distributed machine learning inference in the private network environment provides. For example, the user device 100 may connect to a web page and may output a user interface screen capable of writing the inference request in which various components are included. In the specification, the inference request may be one of business processes. For example, the inference request may be a text of content such as “Please schedule a study plan by referring to my wrong answer note.”.

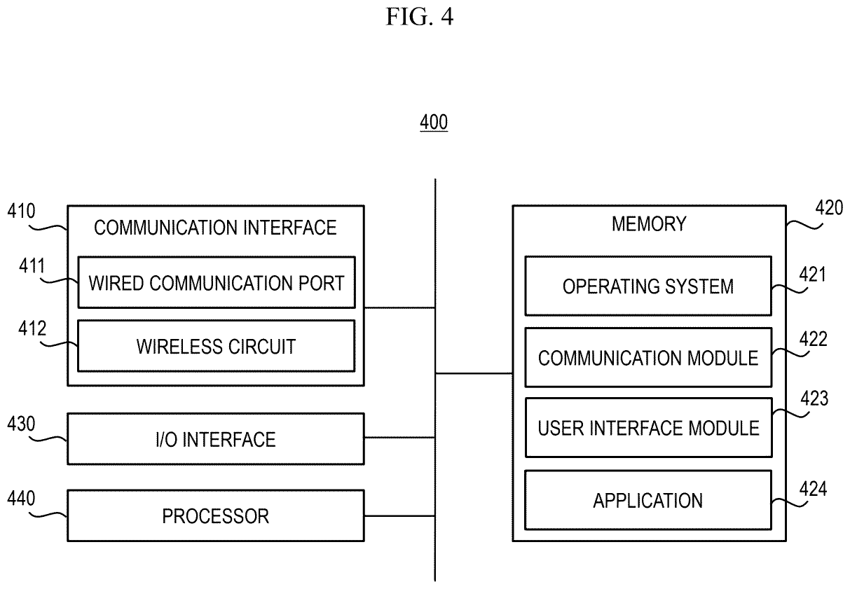

FIG. 4 is a block diagram illustrating a configuration of a computing device for distributed machine learning inference according to an embodiment of the present disclosure.

Referring to FIG. 4, a computing device 400 for distributed machine learning inference according to an embodiment of the present disclosure may be a computing device which provides an inference result of a machine learning model depending on a request of the user (e.g., a user device) or may be a user device on which a web page, an application, and/or a program capable of providing the inference result of the machine learning model is installed and executed. The computing device 400 for distributed machine learning inference may correspond to the serve queue 300 of FIG. 3 or hardware where the serve queue 300 is built.

The computing device 400 for distributed machine learning inference may include a communication interface 410, a memory 420, an I/O interface 430, and/or a processor 440, which communicate with each other through one or more communication buses or signal lines.

The communication interface 410 may be connected to the user device (not illustrated) over a wired/wireless communication network to exchange data. For example, the communication interface 410 may receive the inference request from the user device or may receive the inference request from the server resource. Also, the communication interface 410 may transmit monitoring data including logs and/or metrics to the user device. The monitoring data which are transmitted to the user device may be data obtained by performing “compression and deployment” and indexing on logs or metrics.

Meanwhile, the communication interface 410 which enables the transmission/reception of the data may include a wired communication port 411 and a wireless circuit 412. Herein, the wired communication port 411 may include one or more wired interfaces, for example, Ethernet, universal serial bus (USB), IEEE1394 (e.g., FireWire, Apple: i. Link, Sonny: Lynx, or Texas Instrument), etc. Also, the wireless circuit 412 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VoIP, Wi-MAX, or any other appropriate communication protocol.

The memory 420 may store a variety of data which are used in the computing device 400 for distributed machine learning inference. For example, the memory 420 may store logs, metrics, system metrics, and/or metadata of files, which are generated from workloads. For another example, the memory 420 may store length information of the message queue according to an embodiment of the present disclosure, a metric capable of being utilized by the horizontal pod autoscaler (HPA), and system status information.

In various embodiments, the memory 420 may include a volatile or nonvolatile recording medium capable of storing various kinds of data, commands, and/or information. For example, the memory 420 may include a storage medium of at least one type of the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), a network storage, a cloud, and a blockchain database.

In various embodiments, the memory 420 may store at least one of an operating system 421, a communication module 422, a user interface module 423, and one or more applications 424.

The operating system 421 (e.g., an embedded operating system such as LINUX, UNIX, MAC OS, WINDOWS, or VxWorks) may include various software components and drivers for controlling and managing general system tasks (e.g., memory management, storage device control, and power management) and may support communication between various hardware, firmware, and software components.

The communication module 422 may support communication with any other device through the communication interface 410. The communication module 422 may include various software components for processing data received by the wired communication port 411 or the wireless circuit 412 of the communication interface 410.

The user interface module 423 may receive a request or an input of the user from a keyboard, a touchscreen, a keyboard, a mouse, microphone through the I/O interface 430 and may provide a user interface on a display.

The application 424 may include a program or a module which is configured to be executable by one or more processors 440. Herein, an application which provides a service for processing all processes for distributed machine learning inference, including machine learning management, message queue control for holding and management of the inference request, message queue monitoring, inference request scheduling, etc., may be implemented on a server farm.

The I/O interface 430 may connect an input/output device (not illustrated) of the computing device 400 for distributed machine learning inference, for example, at least one of a display, a keyboard, a touchscreen, and a microphone with the user interface module 423. The I/O interface 430 may receive a user input (e.g., a voice input, a keyboard input, or a touch input) together with the user interface module 423 and may process a command according to the received input.

The processor 440 may be connected to the communication interface 410, the memory 420, and the I/O interface 430 to control all operations of the computing device 400 for distributed machine learning inference and may perform various commands for distributed machine learning inference through the application or the program stored in the memory 420.

The processor 440 may correspond to a computing device such as a central processing unit (CPU) or an application processor (AP). Also, the processor 440 may be implemented in the form of an integrated chip (IC) such as a system on chip (SoC) in which various computing devices are integrated. In addition, the processor 440 may include a module for calculating an artificial neural network model such as a neural processing unit (NPU).

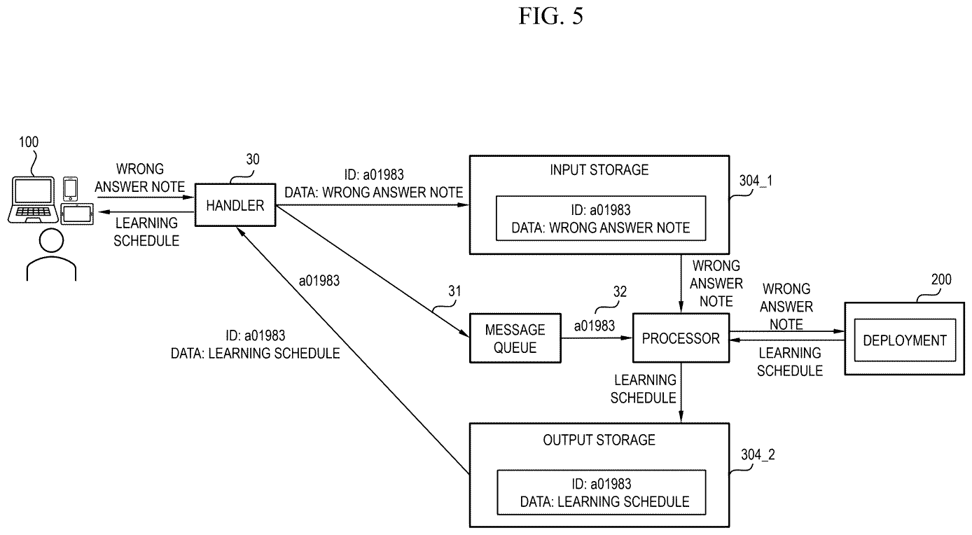

FIG. 5 is a block diagram illustrating an example of an operation of a distributed machine learning inference system according to an embodiment of the present disclosure.

FIG. 5 shows an operation of a distributed machine learning inference system which outputs a learning schedule in response to the inference request of the user, including content such as “Please schedule a study plan by referring to my wrong answer note.”, based on data.

The user device 100 may transmit a wrong answer note corresponding to input data to the handler 30. In this case, the handler 30 may transmit the wrong answer note to an input storage 304_1 together with identification information ID:a01983 about the corresponding wrong answer note. The input storage 304_1 may store the wrong answer note and the identification information about the corresponding wrong answer note. The handler 30 may transmit only the identification information ID:a01983 of data associated with the corresponding inference request to a message queue 31.

The message queue 31 may store the identification information ID:a01983 of the data associated with the corresponding inference request. The processor 32 may check the received identification information, may request the data corresponding to the identification information from the input storage 304_1, and may receive the wrong answer note from the input storage 304_1.

The processor 32 may schedule the inference request. In detail, the processor 32 may deploy the inference service by using the deployment function of the Kubernetes and may perform the autoscaling according to a load by using the horizontal pod autoscaler (HPA). In this case, the processor 32 may transmit the wrong answer note to a first server which is one of the plurality of servers 200.

As an example, the first server which is one of the plurality of servers 200 may output at least a part of the learning schedule as the inference result by using the machine learning model receiving the inference request as an input. A second server, a third server, and/or a fourth server which is one of the plurality of servers 200 may output at least part of the learning schedule as the inference result. The at least a part of the learning schedule may be one of four-week learning schedules of the user and may be referred to as a “chunk” or a “data chunk”.

The at least a part (e.g., the first-weak learning schedule among the four-week learning schedules of the user) of the learning schedule which the first server being one of the plurality of servers 200 outputs may be transmitted to the processor 32 in real time. The processor 32 may transmit the at least a part of the learning schedule thus received to an output storage 304_2 together with the identification information ID:a01983 about the learning schedule. The output storage 304_2 may store the learning schedule together with the identification information about the corresponding learning schedule.

After the handler 30 transmits the identification information ID:a01983 of the data associated with the inference request to the message queue 31, the handler 30 may continuously monitor the output storage 304_2. When an event that at least a part of the learning schedule corresponding to a part of the inference result is stored in the output storage 304_2 occurs, the handler 30 may detect the event and may return the at least a part of the learning schedule and identification information thereof to the user device 100. Like at least a part of the learning schedule which the first server outputs, when the event that at least a part (e.g., the second-weak learning schedule among the four-week learning schedules of the user) of the learning schedule which the second server being one of the plurality of servers 200 is transmitted to the processor 32 and is stored in the output storage 304_2 occurs, the handler 30 may detect the event and may return the at least a part of the learning schedule and identification information thereof to the user device 100.

In this way, at least a part of the inference result which one server included in the plurality of servers 200 outputs may be returned to the user in real time by using the serve queue 300, the message queue 31, and the output storage 304_2, and thus, the user may use the inference service in an environment similar to an environment where the user directly communicates with a real server computer.

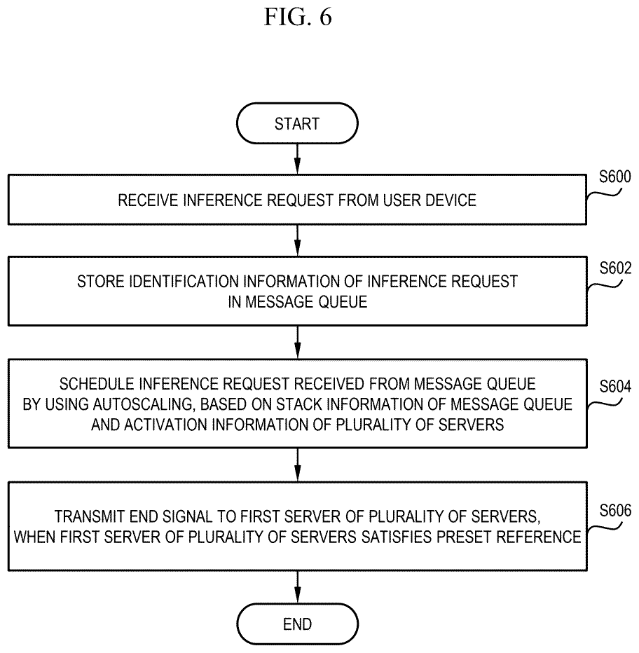

FIG. 6 is a flowchart illustrating an operating method of a computing device for distributed machine learning inference according to an embodiment of the present disclosure. For convenience of description, below, a computing device for distributed machine learning inference is referred to as a “computing device”.

The computing device 400 may receive the inference request from the user device (S600).

The computing device 400 may store identification information of the inference request in the message queue (S602).

The computing device 400 may schedule the inference request received from the message queue by using the autoscaling, based on stack information of the message queue and activation information of a plurality of servers (S604).

When a first server among the plurality of servers satisfies a preset reference, the computing device 400 may transmit an end signal to the first server among the plurality of servers (S606). Herein, the preset reference may mean the case where at least one of the plurality of servers is in an inactive during a first time determined in advance and the inference request is not received from the user device during a second time determined in advance.

In an embodiment, when a first inference request is received and the plurality of servers 200 are in the 0-to-1 situation, the computing device 400 may transmit the wakeup signal to an arbitrary server (e.g., the second server) allocated by scheduling from among the plurality of servers 200. The computing device 400 may store the first inference request in the message queue to hold (or queue) the first inference request. The computing device 400 may transmit the first inference request to the second server after a preset time.

In an embodiment, the computing device 400 may detect a second inference request failing in generation of an inference result. The computing device 400 may control the message queue such that the priority of the second inference request becomes higher. The computing device 400 may again transmit the second inference request to an arbitrary server (e.g., the third server) allocated by scheduling from among the plurality of servers 200.

The distributed machine learning inference system 3000 for the private network environment according to an embodiment may include a computer program which is stored in a computer-readable recording medium coupled to a computer or a computing device, which is hardware, and performs step S600 to step S606 of FIG. 6 described above.

The distributed machine learning inference system 3000 may be implemented with a computing device including at least one processor which executes instructions of programs loaded to a memory. A program including the instructions described to execute step S600 to step S606 of FIG. 6 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g., CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, as the number of server resources is dynamically adjusted depending on a load of a distributed machine learning inference system through autoscaling and scale-to-zero functions, unnecessary resource waste may be prevented, and costs may be reduced.

According to embodiments, even when there is no server resource, an inference request may be received through an asynchronous request processing manner utilizing a message queue and may be processed after a server wakes up. In this case, it is possible to provide a stable service to the user.

According to embodiments, as a request is safely reprocessed through a monitoring and error processing mechanism even when an error occurs in a processor or server, the reliability and stability of the distributed machine learning inference system may become higher.

According to embodiments, as various inference services are operated simultaneously through an integrated architecture in which the Kubernetes and a message queue system are linked, the scalability and flexibility of the system may be improved.

According to embodiments, as the distributed machine learning inference system is designed to operate in a private network environment without depending on a cloud service, the distributed machine learning inference system is capable of being utilized even in an environment where data security and regulatory compliance are important.

According to the above description, companies or institutions which operate the machine learning inference service may provide a stable service while efficiently managing a computing resource, and thus, costs may be reduced, and the quality of service may be improved.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A system for distributed machine learning inference in a private network environment, comprising:
a user device; and
a serve queue configured to:
receive an inference request from the user device,
to store identification information of the inference request in an asynchronous message queue whose execution time is dynamically determined,
to schedule the inference request by using autoscaling, based on stack information of the message queue and activation information of a plurality of servers,
when a first server among the plurality of servers satisfies a preset reference, to perform a scale-to-zero on the first server by transmitting an end signal to the first server, and
when all of the plurality of servers are inactive, to perform a 0-to-1 to activate at least one of the plurality of servers by transmitting a wakeup signal to at least one of the plurality of servers;
wherein each of the plurality of servers are configured to generate an inference result in response to the inference request allocated from the serve queue. wherein the preset reference is the case where at least one of the plurality of servers is in an inactive during a first time determined in advance and an inference request is not received from the user device during a second time determined in advance.

2. The system for distributed machine learning inference of claim 1, wherein the inference request includes a first inference request, and
wherein the serve queue is further configured to:
detect the first inference request failing in generation of an inference result;
control the message queue such that a priority of the first inference request becomes higher; and
again transmit the first inference request to a second server among the plurality of servers.

3. The system for distributed machine learning inference of claim 1, wherein the inference request includes a second inference request, and
wherein the serve queue is further configured to:
when the second inference request is received and the plurality of servers are in a 0-to-1 situation,
transmit a wakeup signal to a third server among the plurality of servers;
store the second inference request in the message queue to hold the second inference request; and
transmit the second inference request to the third server among the plurality of servers after a third time determined in advance.

4. The system for distributed machine learning inference of claim 1, further comprising:
a storage including an input storage and an output storage,
wherein the input storage is configured to store data associated with the inference request, and
wherein the output storage is configured to store data associated with the inference result.

5. The system for distributed machine learning inference of claim 4, wherein the autoscaling is to dynamically determine whether to activate each of the plurality of servers by using a horizontal pod autoscaler (HPA) function of Kubernetes.

6. An operating method for distributed machine learning inference in a private network environment, the method comprising:
receiving an inference request from a user device, wherein the inference request includes a first inference request and a second inference request;
storing identification information of the inference request in an asynchronous message queue whose execution time is dynamically determined;
scheduling the inference request by using autoscaling, based on stack information of the message queue and activation information of a plurality of servers;
when a first server among the plurality of servers satisfies a preset reference, performing a scale-to-zero on the first server by transmitting an end signal to the first server; and
when all of the plurality of servers are inactive, performing a 0-to-1 to activate at least one of the plurality of servers by transmitting a wakeup signal to at least one of the plurality of servers,
wherein each of the plurality of servers are configured to generate an inference result in response to the inference request allocated from the serve queue, and
wherein the preset reference is the case where at least one of the plurality of servers is in an inactive during a first time determined in advance and an inference request is not received from the user device during a second time determined in advance.

7. The method of claim 6, wherein the performing the scale-to-zero on the first server includes: when the first inference request is received and the plurality of servers are in a 0-to-1 situation,
transmitting a wakeup signal to a second server among the plurality of servers;
storing the first inference request in the message queue to hold the first inference request; and
transmitting the first inference request to the second server among the plurality of servers after a time determined in advance.

8. The method of claim 7, further comprising:
detecting the second inference request failing in generation of an inference result from the plurality of servers;
controlling the message queue such that a priority of the second inference request becomes higher; and
again transmitting the second inference request to the second server among the plurality of servers.

9. A non-transitory computer-readable recording medium having recorded thereon a computer program for executing an operating method for distributed machine learning inference in a private network environment, the operating method comprising:
receiving an inference request from a user device, wherein the inference request includes a first inference request and a second inference request;
storing identification information of the inference request in an asynchronous message queue whose execution time is dynamically determined;
scheduling the inference request by using autoscaling, based on stack information of the message queue and activation information of a plurality of servers;
when a first server among the plurality of servers satisfies a preset reference, performing a scale-to-zero on the first server by transmitting an end signal to the first server; and
when all of the plurality of servers are inactive, performing a 0-to-1 to activate at least one of the plurality of servers by transmitting a wakeup signal to at least one of the plurality of servers,
wherein each of the plurality of servers are configured to generate an inference result in response to the inference request allocated from the serve queue, and
wherein the preset reference is the case where at least one of the plurality of servers is in an inactive during a first time determined in advance and an inference request is not received from the user device during a second time determined in advance.
